(19) United States
(12) Patent Application Publication
(10) Pub. No.: US 2006/0068189 A1
(43) Pub. Date: Mar. 30, 2006

(54) Method of forming stabilized plasma-sprayed thermal barrier coatings

(76) Inventors: Derek Raybould, Denville, NJ (US); Thomas E. Strangman, Prescott, AZ (US); Paul Chipko, Blairstown, NJ (US)

Correspondence Address: HONEYWELL INTERNATIONAL, INC., Law Dept. AB2, P.O. Box 2245, Morristown, NJ, 07962-9806, US

(21) Appl. No.: 10/952,110

(22) Filed: Sep. 27, 2004

(51) Int. Cl. B32B 3/06; B32B 5/14; B32B 3/00; B32B 15/04

(52) U.S. Cl. 428/307.3; 428/469; 428/307.7; 428/312.2; 428/312.6; 428/312.8; 427/226; 427/372.2

(57) ABSTRACT

A method for stabilizing a porous thermal barrier coating plasma sprayed on a substrate comprises the steps of immersing the porous thermal barrier coating in a sol gel comprising a metal oxide or precursor thereof, a solvent, and a surfactant, applying vacuum pressure to the sol gel to infiltrate the porous thermal barrier coating with the sol gel, and drying the sol gel to produce residual metal oxide particles in the porous thermal barrier coating.

### TECHNICAL FIELD

The present invention relates to thermal barrier coatings that are applied to superalloy substrates and, more particularly, to a ceramic thermal barrier coating that has a maintained low thermal conductivity.

### BACKGROUND

Turbine engines are used as the primary power source for various kinds of aircrafts. The engines are also auxiliary power sources that drive air compressors, hydraulic pumps, and industrial gas turbine (IGT) power generation. Further, the power from turbine engines is used for stationary power supplies such as backup electrical generators for hospitals and the like.

Most turbine engines generally follow the same basic power generation procedure. Compressed air is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more air into the engine and the high velocity combustion gas is passed out of the gas turbine aft end to create forward thrust. Other engines use this power to turn one or more propellers, electrical generators, or other devices.

Many turbine blades and vanes are formed from a superalloy such as a nickel-based superalloy. Although nickel-based superalloys have many advantages such as good high temperature properties, they are susceptible to corrosion, oxidation, and even melting in the high temperature environment of an operating turbine engine. These limitations are problematic as there is a constant drive to increase engine operating temperatures in order to increase engine power and efficiency.

One approach directed toward overcoming some temperature-related limitations of nickel-based superalloys, and thereby enabling an increase of engine temperatures, has been to apply a protective thermal barrier coating over at least some of the superalloy surface area to insulate the blades and vanes and consequently reduce the temperature that the superalloy experiences. U.S. Pat. No. 6,103,386 describes a ceramic thermal barrier coating that is applied over a superalloy by electron beam physical vapor deposition (EB PVD). Depositing the ceramic material by EB PVD causes the thermal barrier coating to have a columnar microstructure with grains that extend substantially perpendicular to the superalloy surface. Between the individual columnar grains are micron sized gaps that can reduce the effective modulus of the ceramic material in the plane of the thermal barrier coating, and consequently increases compliance of the ceramic material. Increased compliance provided by the gaps enhances coating durability by eliminating or minimizing stresses associated with a thermal gradient and a superalloy/ceramic thermal expansion coefficient mismatch.

Plasma spraying is another method by which a ceramic thermal barrier coating can be applied to a superalloy substrate. Thermal barrier coatings that are applied by plasma spraying have several advantages, including low cost and low initial thermal conductivity. Plasma spraying creates an interconnected network of subcritical microcracks with micron-width opening displacements that reduce the effective modulus of the ceramic material. The microcracks do not define an overall columnar microstructure for the ceramic thermal barrier coating, although the cracks do tend to provide some compliance. Compliance can be increased by forcing the creation of vertical cracks by, for instance, machining ridges in the superalloy or even laser cutting vertical groves into the coating a laser. Such vertical cracks perform the same function as the gaps in the EB PVD-formed coating.

Plasma sprayed ceramic thermal barrier coatings have a high porosity when compared with EB-PVD-formed coatings. The high porosity imparts the advantage of low thermal conductivity to the coating. However, the high operational temperatures inside a turbine engine causes the pores in the ceramic material to sinter closed, and the thermal conductivity quickly approaches that of the fully dense solid.

Hence, there is a need for methods of forming and modifying a plasma sprayed thermal barrier coating over a superalloy substrate in a manner that enables the coating to maintain low thermal conductivity properties. More particularly, there is a need for methods of treating porous thermal barrier coatings to prevent the coating from sintering and the consequential loss of low thermal conductivity.

### BRIEF SUMMARY

The present invention provides a method for stabilizing a porous thermal barrier coating plasma sprayed on a substrate. The method comprises the steps of immersing the porous thermal barrier coating in a sol gel comprising a metal oxide or precursor thereof, a solvent, and a surfactant, applying vacuum pressure to the sol gel to infiltrate the porous thermal barrier coating with the sol gel, and drying the sol gel to produce residual metal oxide particles in the porous thermal barrier coating.

In one embodiment, and by way of example only, the sol gel substantially infiltrates the entire porous thermal barrier coating when subjected to the vacuum pressure. In another embodiment, and by way of example only, the method further comprises the step of heating the porous thermal barrier coating after the drying step to bond the metal oxide particles with the porous thermal barrier coating.

Other independent features and advantages of the preferred method will become apparent from the following detailed description, taken in conjunction with the accompanying drawings which illustrate, by way of example, the principles of the invention.

### BRIEF DESCRIPTION OF THE DRAWINGS

FIG. 1 is a sectional view of an article such as a turbine airfoil that includes a substrate and a thermal barrier coating;

FIG. 2 is a cross section (500× magnification) of a plasma sprayed thermal barrier coating having pores extending throughout the entire coating thickness;

FIG. 3 is a cross section (3000× magnification) of a pore within a ceramic thermal barrier coating, and with alumina particles distributed inside the pore; and

FIG. 4 is a diagram illustrating a process for thoroughly infiltrating a thermal barrier coating with stabilizing particles.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides cost-efficient methods that include plasma spraying a thermal barrier coating over a substrate, and thereafter infiltrating pores within the thermal barrier coating with stabilizing particles. The stabilizing particles advantageously prevent the coating from sintering, and therefore maintain low thermal conductivity for the thermal barrier coating.

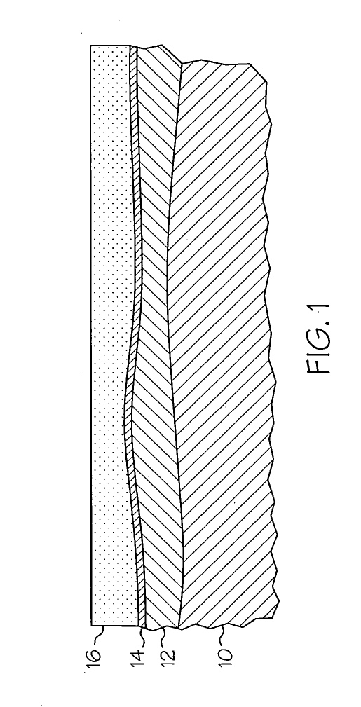

A sectional view of an article such as a turbine airfoil that includes a substrate and a thermal barrier coating according is illustrated in FIG. 1. The substrate 10 can be a nickel, cobalt, or iron based high temperature alloy from which turbine airfoils are commonly made. In an exemplary embodiment, the substrate 10 is a superalloy having hafnium and/or zirconium, and particular examples of such superalloys are listed in Table 1.

TABLE 1

| Alloy | Mo | W | Ta | Al | Ti | Cr | Co | Hf | V | Zr | C | B | Ni |
|---|---|---|---|---|---|---|---|---|---|---|---|---|---|
| Mar-M247 | .65 | 10 | 3.3 | 5.5 | 1.05 | 8.4 | 10 | 1.4 | — | .55 | .15 | .15 | bal. |
| IN-100 | 3.0 | — | — | 5.5 | 4.7 | 9.5 | 15.0 | — | 1.0 | .06 | .17 | .015 | bal. |
| Mar-M509 | — | 7.0 | 3.5 | — | 0.25 | 23.4 | bal. | — | — | .5 | .6 | — | 10.0 |

A bond coat 12 lies over the substrate 10. The bond coat 12 is typically a MCrAlY alloy, which is known in the art. Typically the MCrAlY is applied by plasma spraying. In one embodiment, an MCrAlY alloy has a general composition of 10 to 35% chromium, 5 to 15% aluminum, 0.01 to 1% yttrium, hafnium, or lanthanum, with the balance M selected from iron, cobalt, nickel, and mixtures thereof. Minor amounts of other elements such as Ta or Si may also be included. The MCrAlY bond coat can be applied by electron beam vapor deposition, sputtering, low pressure plasma spraying, and high velocity oxy-fuel processing.

The bond coat 12 is optional if the substrate 10 is capable of forming a highly adherent oxide layer thereon, which is illustrated as layer 14. Exemplary substrates that are viable without the bond coat 12 are nickel-base superalloys having less than 1 part per million sulfur content and/or an addition of 0.01 to 0.1 percent by weight yttrium to the alloy chemistry.

An oxide layer 14 is formed as a result of either oxidation of the bond coat 12 or oxidation of the substrate 10 if a bond coat 12 is absent. The alumina layer 14 provides both oxidation resistance and a bonding surface for the later-described thermal barrier coating 16.

The thermal barrier coating 16 is applied using a plasma spraying process. The thermal barrier coating 16 may be any conventional ceramic composition that has a thermal conductivity that is lower than that of the substrate 10 and that is stable in the high temperature environment of a gas turbine. Exemplary compositions include zirconia that is stabilized with an oxide such as CaO, MgO, CeO₂, and Y₂O₃. Other exemplary ceramic compounds include hafnia and ceria, which can also be stabilized with an oxide such as Y₂O₃. The plasma sprayed thermal barrier coating 16 has a thickness that may vary between 10 and 1000 microns. A model thermal barrier coatings includes about 7 weight % yttria stabilized zirconia. Such coatings are particularly suited for infiltration by sol gel alumina and subsequent formation of particles of alpha alumina.

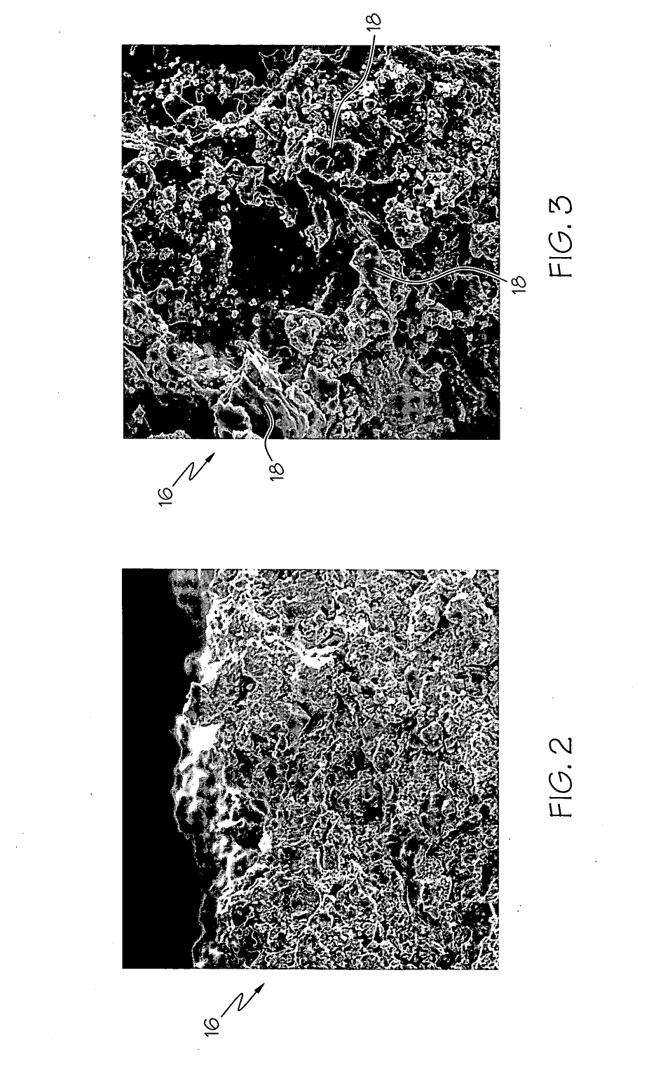

Plasma spraying creates a ceramic thermal barrier coating that has beneficial porosity, which imparts low thermal conductivity to the coating 16. Infiltrating the micro- and nano-sized pores with stabilizing particles inhibits sintering induced pore closure during subsequent high temperature exposure inside a turbine engine. FIG. 2 illustrates a cross section of a plasma sprayed thermal barrier coating (10 μm width, magnification 500×), and depicts the pores extending throughout the entire coating thickness. FIG. 3 is a cross section of a pore that is structurally defined by the ceramic material forming the thermal barrier coating (1 μm width, magnification 3000×), with alumina particles 18 distributed inside the pore. As shown in FIG. 3, the particles 18 are distributed discontinuously. In other words, the particles 18 are discrete clusters within the thermal barrier coating pores and do not form a uniform or continuous coating along the thermal barrier coating exterior or interior. Consequently, the particles 18 do not provide any significant or meaningful protection to the thermal barrier coating 16 against environmental contaminants such as calcium-magnesium-aluminum-silicon-oxide system (CMAS) deposits and corrosive deposits. However, the particles 18 still provide sufficient structural support to substantially prevent pore closure and densification of the thermal barrier coating 16 at temperatures higher than 1100° C. which are typical operating temperatures for a turbine blade or vane. Further, the particles 18 only partially fill the pores inside the thermal barrier coating 16, and leave enough space for air to occupy the majority of the pore volume. Another important aspect of the invention is the thorough infiltration of the particles 18 throughout the thermal barrier coating 16, and not merely at the coating surface or an outer coating region or layer.

In an exemplary embodiment of the invention, the particles 18 have a different coefficient of thermal expansion than the thermal barrier coating 16. As the pore shrinks during a later-described post infiltration thermal treatment, the pore walls will come into contact with the particles 18 and either bond to the particles or exert significant pressure on them as it tries to contract further. As the pores close around the particles 18, the thermal conductivity of the thermal barrier coating will approach that of the non-porous solid. However, since the particles 18 have a different coefficient of thermal expansion they will break away from the thermal barrier as it cools down from operating temperature, maintaining a void and thus a relatively low thermal conductivity.

The particles 18 may react with the thermal barrier coating 16 provided they form a stable compound that preferably has a different thermal expansion coefficient than the thermal barrier coating 16. In an exemplary embodiment, a separate heat treatment is performed to ensure that such reactions are controlled and that the desired phases of the resultant compound are formed.

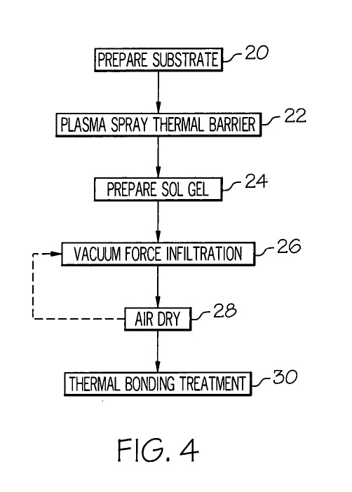

A process for thoroughly infiltrating the thermal barrier coating 16 with stabilizing particles 18 will now be described with reference to the diagram of FIG. 4. First, step 20 includes preparing a substrate for plasma spraying a thermal barrier coating. For the purposes of this step 20, preparing the substrate at least comprises providing the previously-discussed substrate 10 depicted in FIG. 1 and further comprises formation of the bond coat 12 and/or the oxide layer 14 as necessary and according to the processes previously discussed.

Next, step 22 includes plasma spraying the thermal barrier coating 16 onto the substrate 10 and also onto any layers formed on the substrate 10. Various plasma spray techniques known to those skilled in the art can be utilized to apply the thermal barrier coating 16. Typical plasma spray techniques involve the formation of a high temperature plasma that produces a thermal plume. Ceramic thermal barrier coating materials are fed into the plume, and the plume is directed toward the substrate 10. The coating materials form a porous solid with low thermal conductivity on the substrate 10 and any other layers formed thereon such as the bond coat 12 and/or the oxide layer 14.

Preparation of a sol gel is represented as step 24 in FIG. 4, although this step can be performed at any time before the later-described infiltration step 26. The sol gel solution is prepared by mixing a metal oxide or precursor such as an alkoxide with a suitable solvent and a surfactant. Exemplary metal oxides or precursors include silica, alumina, and titania. Exemplary solvents include xylene and alcohols, and preferably all solvents are essentially water-free. A dry solvent is particularly beneficial when an alumina precursor is to be used in the sol gel. The metal oxide or precursor is mixed a concentration ranging between 2 and 20% by weight. Mixing should be performed until all of the metal oxide or precursor is dissolved in the solvent. The mixed sol gel has a viscosity of 1 centipoise or less.

After mixing is completed, a surfactant is added to the mixture. The surfactant reduces surface tension and hence improves wetting. Many surfactants to improve wetting are readily available commercially. Exemplary surfactants include anionic surfactants such as those used in liquid dish soap and other surfactants used in aqueous cleaners that provide detergency, emulsification, and wetting action. Other exemplary anionic surfactants include linear alkylbenzene sulfonate, alcohol ethoxysulfates, alkyl sulfates and other types of soaps. Such surfactants are typically biodegradable. Only a few drops of the surfactant are required for a 1000 ml sol gel solution and leave no soap trace after the sol gel is dried, although even lower detergent concentrations are effective. Cationic, nonionic, and anionic surfactants can also be effectively used.

Step 26 includes placing the component coated with the plasma-sprayed thermal barrier coating 16 into a container with the sol gel solution, and applying a vacuum to the container to force the sol gel solution to infiltrate the thermal barrier coating pores. Infiltration is optimized if the thermal barrier coating 16 is degreased in ethyl alcohol and dried before it is placed in contact with the sol gel. In an exemplary embodiment, a vacuum is approximately twenty-five inches of Hg is applied for about 5 minutes, although the vacuum can range between greater than twelve inches of Hg and less than twenty nine inches of Hg. Lower vacuums such as 12 inches of Hg would require longer times of 12 to 30 min. Higher vacuums than ˜29 inches of Hg might reduce the time, but would require relatively expensive equipment, which would not be economically attractive. The low concentration of metal oxide or precursor, coupled with the presence of the surfactant, enables the sol gel to thoroughly infiltrate the thermal barrier coating 16.

After the vacuum-forced or vacuum-enhanced sol gel infiltration is completed, the turbine airfoil or other article formed from the substrate 10 is removed from the sol gel container and is air dried, represented as step 28 in FIG. 4. Air drying takes place at room temperature and at ambient pressure, and typically takes at least 4 to 8 hours for thorough drying. Moisture in the air reacts with the metal oxide or metal oxide precursor in the sol gel to form solid particles in the thermal barrier coating pores. Since the pores were thoroughly infiltrated with the sol gel, the solid particles can be larger than the pore openings at the thermal barrier coating outer surface, and can provide support for large spaces in the pores to prevent the spaces from sintering closed. The air drying step 28 further includes a stabilizing heat treatment at 200 to 300° C. for one to two hours after drying. Although the vacuum-forced infiltration step 26 and air drying step 28 typically provide thorough infiltration and support of the porous thermal barrier coating 16, the two steps can be repeated if additional metal oxide particles are necessary to further support the pores and maintain low thermal conductivity for the thermal barrier coating 16, although repeating the dipping operation more than about 5 times and/or using a higher metal oxide concentration solution will result in the complete filling of all the pores. If the pores are completely filled, the compliance that the pores provide the thermal barrier coating with is lost. In fact, during cyclic oxidation testing at 2100° F. a plasma sprayed thermal barrier coating with substantially completely filled pores debonded from the superalloy substrate leaving it un protected.

After the airfoil or other article formed from the substrate 10 is dried and stabilized a thermal bonding treatment is performed, represented as step 30 in FIG. 4. The thermal bonding treatment includes applying at least one heat treatment for one to two hours at temperatures ranging between about 550° C. and about 1300° C., and preferably about at about 1,000° C. Higher temperatures potentially could damage the thermal barrier coating. Depending on the temperature, the heat treatment can be performed for a period ranging from 0.25 to 20 hrs. The high temperatures cause the metal oxide particles 18 to densify, and to bond with the thermal barrier coating compounds to some degree. The bonded particles 18 advantageously prevent the coating from sintering, and therefore maintain low thermal conductivity for the thermal barrier coating 16.

### EXAMPLE

A 910 ml alumina sol gel solution was prepared in a 1000 ml container by first pouring 700 ml xylene into the container and then mixing 70 g of aluminum isoproxide with the xylene. The solution was mixed using a magnetic stirrer until all the aluminum isoproxide was dissolved in the solution. 140 ml of methanol was added to the solution and mixed for several hours. 0.38 ml of detergent (liquid soap) was added as a surfactant and mixed well into the sol gel solution.

The sol gel solution was transferred to a low vacuum vessel for vacuum-forced infiltration. A turbine blade with a plasma-sprayed zirconia coating formed thereon was placed in the low vacuum vessel and entirely submerged in the sol gel solution. A vacuum of approximately 25 inches of Hg was applied to the vessel interior. Bubbles were observed escaping from the porous zirconia coating as a result of the vacuum. After five minutes, bubbling from the zirconia coating ceased to indicate through infiltration by the sol gel, and the vacuum was released. The turbine blade was removed from the vessel, and the blade was fully air dried. Any excess dried solution was gently blown from the blade surface to avoid coating the surface. Next, the blade was placed in a furnace at 200° C. for one hour in air. Finally, the blade was placed in a vacuum furnace and heated for one hour at 1000° C. After the thermal bonding treatment in the vacuum furnace was completed, the blade was cooled in an ambient environment.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for stabilizing a porous thermal barrier coating plasma sprayed on a substrate, comprising the steps of:
immersing the porous thermal barrier coating in a sol gel comprising a metal oxide or precursor thereof, a solvent, and a surfactant;
applying vacuum pressure to the sol gel to substantially infiltrate the entire porous thermal barrier coating with the sol gel;
drying the sol gel to produce discrete residual metal oxide particles in the porous thermal barrier coating; and
heating the porous thermal barrier coating to bond the metal oxide particles with the porous thermal barrier coating.

2. The method according to claim 1, wherein the metal oxide particles are dispersed in the pores through substantially all of the thermal barrier coating and in a discontinuous manner to provide no significant environmental protection to the thermal barrier coating.

3. The method according to claim 1, wherein the metal oxide particles have a different thermal expansion coefficient than the thermal barrier coating.

4. The method according to claim 1, wherein the metal oxide particles are inert with respect to the thermal barrier coating.

5. The method according to claim 1, wherein the metal oxide particles react with the thermal barrier coating and form stable compounds having a different thermal expansion coefficient than the thermal barrier coating.

6. The method according to claim 5, wherein formation of the stable compounds having a different coefficient of thermal expansion than the thermal barrier coating causes the pore volume to increase.

7. The method according to claim 1, wherein the sol gel comprises between 2 and 20% by weight of the metal oxide or precursor thereof.

8. The method according to claim 1, wherein the sol gel is non-aqueous.

9. The method according to claim 1, wherein the solvent in the sol gel includes at least one compound selected from the group consisting of xylene, and alcohols.

10. The method according to claim 1, wherein the metal oxide or precursor thereof is selected from the group consisting of silica, alumina, titania, and mixtures thereof.

11. The method according to claim 1, wherein the surfactant in the sol gel is a detergent.

12. The method according to claim 1, wherein the drying step is performed in the presence of air, and the metal oxide particles are formed at least in part due to reaction with metal oxide precursors with moisture in the air.

13. The method according to claim 1, wherein the metal oxide particles only fill a minority of the total pore volume inside the porous thermal barrier coating.

14. The method according to claim 1, wherein the thermal barrier coating is zirconia or hafnia at least partially stabilized with yttria.

15. The method according to claim 14, wherein the thermal barrier coating is about 7 weight % yttria stabilized zirconia, and the metal oxide particles are silica.

16. The method according to claim 14, wherein the thermal barrier coating is about 7 weight % yttria stabilized zirconia, and the metal oxide particles are alpha alumina.

17. The method according to claim 1, wherein the substrate is a turbine airfoil.

18. A method for stabilizing a porous thermal barrier coating plasma sprayed on a substrate, comprising the steps of:
immersing the porous thermal barrier coating in a sol gel comprising a metal oxide or precursor thereof, a solvent, and a surfactant;
applying vacuum pressure to the sol gel to infiltrate the porous thermal barrier coating with the sol gel; and
drying the sol gel to produce discrete residual metal oxide particles in the porous thermal barrier coating.

19. The method according to claim 18, wherein the metal oxide particles are dispersed in the pores through substantially all of the thermal barrier coating and in a discontinuous manner to provide no significant environmental protection to the thermal barrier coating.

20. The method according to claim 18, further comprising the step of:
heating the porous thermal barrier coating after the drying step to bond the metal oxide particles with the porous thermal barrier coating.

21. The method according to claim 18, wherein the sol gel comprises between 2 and 20% by weight of the metal oxide or precursor thereof.

22. The method according to claim 18, wherein the sol gel is non-aqueous.

23. The method according to claim 18, wherein the solvent in the sol gel includes at least one compound selected from the group consisting of xylene, and alcohols.

24. The method according to claim 18, wherein the surfactant in the sol gel is a detergent.

25. The method according to claim 24, wherein the metal oxide particles only fill a minority of the volume inside the porous thermal barrier coating.

26. A method for stabilizing a porous thermal barrier coating plasma sprayed on a substrate, comprising the steps of:
immersing the porous thermal barrier coating in a non-aqueous sol gel comprising between 2 and 20% by weight of a metal oxide or precursor thereof, a solvent, and a surfactant;
applying vacuum pressure to the sol gel to substantially infiltrate the entire porous thermal barrier coating with the sol gel;
drying the sol gel to produce a non-uniform distribution of discrete residual metal oxide particles filling a minority of the volume inside the porous thermal barrier coating; and
heating the porous thermal barrier coating to bond the metal oxide particles with the porous thermal barrier coating,
wherein the metal oxide particles are dispersed in the pores through substantially all of the thermal barrier coating and in a discontinuous manner to provide no significant environmental protection to the thermal barrier coating.

27. A turbine engine component, comprising:
a substrate;
a plasma-sprayed thermal barrier coating formed over at least a portion of the substrate and having nanometer- and micron-sized pores throughout the entire thermal barrier coating; and
discrete stabilizing particles dispersed in the pores through substantially all of the thermal barrier coating and in a discontinuous manner to provide no significant environmental protection to the thermal barrier coating.

28. The turbine engine component according to claim 27, wherein the stabilizing particles comprise a metal oxide having a different thermal expansion coefficient than the thermal barrier coating.

29. The turbine engine component according to claim 28, wherein the metal oxide particles are inert with respect to the thermal barrier coating.

30. The turbine engine component according to claim 27, wherein the stabilizing particles comprise a stable reaction product between a metal oxide and the thermal barrier coating, and have a different thermal expansion coefficient than the thermal barrier coating.

31. The turbine engine component according to claim 27, wherein the stabilizing particles comprise at least one metal oxide selected from the group consisting of silica, alumina, titania, and mixtures thereof.

32. The turbine engine component according to claim 27, wherein the stabilizing particles only fill a minority of the total pore volume inside the porous thermal barrier coating.

33. The turbine engine component according to claim 27, wherein the thermal barrier coating is zirconia or hafnia at least partially stabilized with yttria.

34. The turbine engine component according to claim 33, wherein the thermal barrier coating is about 7 weight % yttria stabilized zirconia, and the metal oxide particles are silica.

35. The turbine engine component according to claim 33, wherein the thermal barrier coating is about 7 weight % yttria stabilized zirconia, and the metal oxide particles are alpha alumina.

36. The turbine engine component according to claim 27, wherein the substrate is a turbine airfoil.
